(19) United States
(12) Patent Application Publication
(10) Pub. No.: US 2014/0355257 A1
(43) Pub. Date: Dec. 4, 2014

(54) ILLUMINATED ARTICLE OF CLOTHING

(71) Applicant: E.S. ORIGINALS, INC., New York, NY (US)

(72) Inventor: Edward J. ANTEBY, Long Branch, NJ (US)

(73) Assignee: E.S. ORIGINALS, INC., New York, NY (US)

(21) Appl. No.: 14/260,462

(22) Filed: Apr. 24, 2014

Related U.S. Application Data
(60) Provisional application No. 61/830,274, filed on Jun. 3, 2013.

(51) Int. Cl. A41D 1/00; F21V 33/00; A41D 13/01

(52) U.S. Cl. CPC A41D 1/002; A41D 13/01; F21V 33/0064
USPC 362/108

(57) ABSTRACT

An illuminated protective garment has light emitting diodes (LEDs) arranged along generally parallel rows along a waist portion of the garment, and a water-resistant module for supplying electrical power to energize the LEDs to emit light. The LEDs in the rows are staggered in position. An ambient light sensor energizes the LEDs upon detection of a predetermined ambient light level. A flexible substrate having conductive strips connects the LEDs to the module. An eyelet surrounds and supports each LED and reflects the light emitted by the respective LED. The LEDs also extend through generally parallel light-reflective bands.

### FIELD OF THE DISCLOSURE

This application claims the priority benefit of U.S. Provisional Patent Application Ser. No. 61/830,274, filed Jun. 3, 2013, the entire contents of which are hereby incorporated herein by reference thereto.

### FIELD OF THE DISCLOSURE

The present disclosure relates generally to illuminated articles of clothing, such as vests, shirts, or coats, and, more particularly, to such garments that are advantageously worn by pedestrians, service personnel, or athletes, e.g., joggers, walkers, or bikers, during periods of low visibility, e.g., during early morning or evening hours, for purposes of safety and protection, especially for avoiding oncoming traffic.

### BACKGROUND

Illuminated, protective garments generally have flashing lights or light emitting diodes (LEDs) attached thereto, powered by a battery pack. Disadvantages common to such garments include relatively limited battery life due to the electrical load required to operate a substantial number of lights; inadequate illumination when fewer lights are used to conserve on energy consumption and prolong battery life; exposed lights or wiring that can be broken during wear; complex circuitry needed to generate flashing signals; difficulty in laundering the garments due to the prior need to disconnect and remove the battery pack; and discomfort in wear due to sharp or raised parts of the circuitry and wiring.

Accordingly, there is a need to increase the battery life, provide adequate illumination, protect the exposed lights or wiring from breakage, simplify the circuitry, make easier the laundering, and provide greater comfort during wear, thereby enhancing usage of such illuminated, protective garments.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a front view of an illuminated protective garment in accordance with one embodiment of this invention.

FIG. 2 is a rear view of the garment of FIG. 1.

FIG. 3 is an enlarged view showing a detail of the front of the garment of FIG. 1.

FIG. 4 is a perspective view of an illumination module for use in the garment of FIG. 1.

FIG. 5 is an enlarged, broken-away, sectional view taken on line 5-5 of FIG. 4.

FIG. 6 is an electrical schematic of the electrical components used in the garment of FIG. 1.

FIG. 7 is an enlarged, broken-away, sectional view taken on line 7-7 of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The structural components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

In accordance with one feature of this invention, an illuminated protective garment, such as a vest, shirt, or coat, includes a back panel overlying a back of a wearer's torso during use, a front panel overlying a front of the wearer's torso during use, and a waist portion integral with the back and front panels and extending circumferentially around the wearer's waist during use. A first plurality of light emitting diodes (LEDs) is arranged in a first row along the waist portion in a spaced apart relationship, and extends through the back and front panels. A second plurality of LEDs is arranged in a second row along the waist portion in a spaced apart relationship, and also extends through the back and front panels. The second row is generally parallel to the first row, and the LEDs of the first row are preferably staggered in position relative to the LEDs of the second row. A lighting module is mounted on the back or the front panel, for supplying electrical power to energize the pluralities of LEDs to emit light.

Advantageously, the module includes a motion-responsive switch for energizing the pluralities of LEDs in response to motion by the wearer, and a processor for energizing the pluralities of LEDs in a flashing pattern. The module includes a battery pack, preferably one or more batteries, and is water-resistant.

In accordance with another feature of this invention, an ambient light sensor is connected to the module, for energizing the pluralities of LEDs upon detection of a predetermined ambient light level. Also, an on/off switch may be connected to the module, for energizing the pluralities of LEDs when the switch is closed in an on state.

In accordance with additional features of this invention, an eyelet surrounds and supports each LED on an exterior surface of the waist portion. Each eyelet is constituted of a reflective material that reflects the light emitted by the respective LED. Also, a pair of light-reflective bands extends along the exterior surface of the waist portion. The LEDs of the first row extend through one of the bands, and the LEDs of the second row extend through the other of the bands. Both the eyelets and the bands enhance the visibility of the garment.

In accordance with yet another feature of this invention, a flexible substrate has conductive strips deposited thereon. The LEDs are connected to the module by the conductive strips. The flexible substrate lies flat against an interior surface of the waist portion and against the wearer's body. This feature enhances comfort, because the flexible substrate conforms to the wearer's body and has no sharp or raised parts.

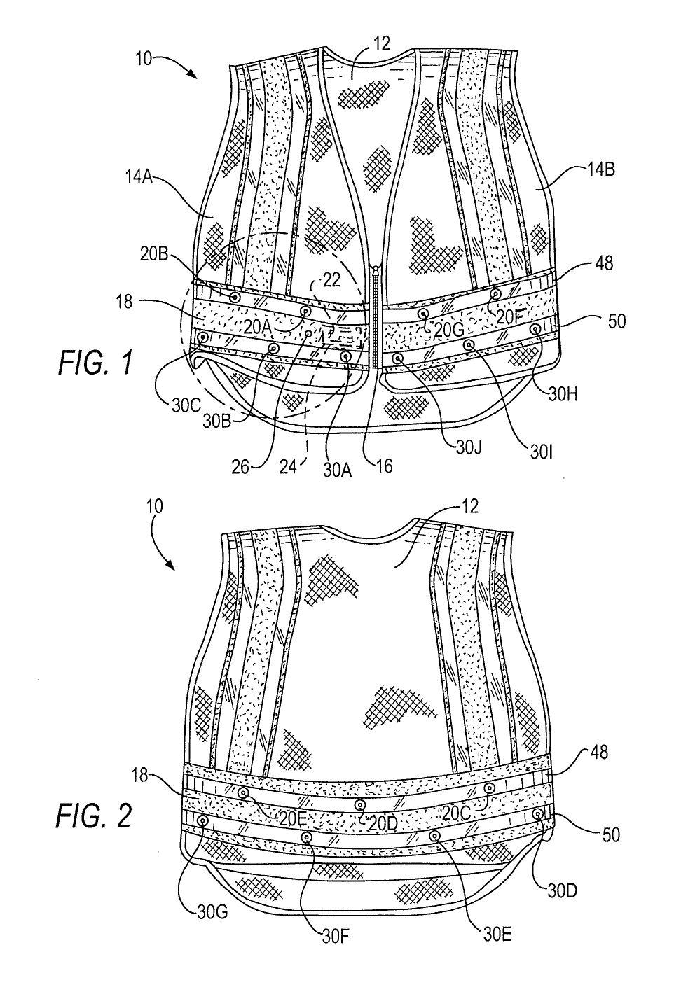

Turning now to the drawings, reference numeral 10 in FIGS. 1-2 generally identifies an illuminated protective garment. As illustrated, the garment 10 is a vest, but other articles of clothing, such as a shirt or a coat, are also contemplated. The garment 10 includes a back panel 12 overlying a back of a wearer's torso during use, and a front panel, which consists of a pair of front panel portions 14A, 14B, overlying a front of the wearer's torso during use. An optional closure 16, such as a zipper, may be used to fasten the front panel portions 14A, 14B together. A waist portion 18 integral with the back and front panels extends circumferentially around the wearer's waist during use. The garment is preferably constituted of a flexible, launderable, lightweight, cloth material.

A first plurality of light sources or light emitting diodes (LEDs) 20A, 20B, 20C, 20D, 20E, 20F, 20G is arranged in a first row along the waist portion 18 in a spaced apart relationship, and extends through the back and front panels. A second plurality of light sources or LEDs 30A, 30B, 30C, 30D, 30E, 30F, 30G, 30H, 301, 30J is arranged in a second row along the waist portion 18 in a spaced apart relationship, and also extends through the back and front panels. The second row is generally parallel to the first row, and the LEDs of the first row are staggered in position relative to the LEDs of the second row.

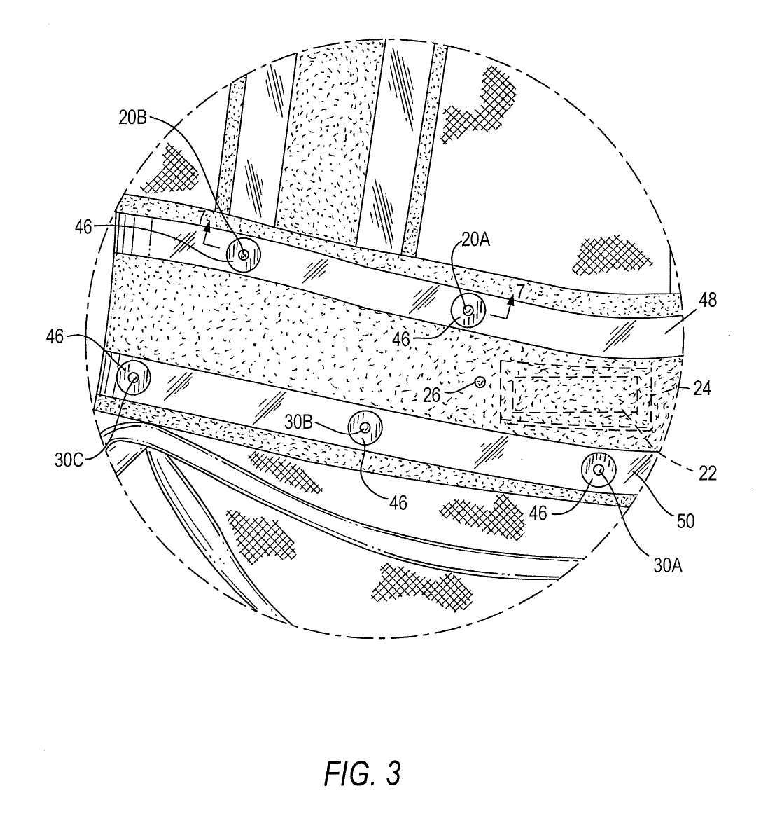

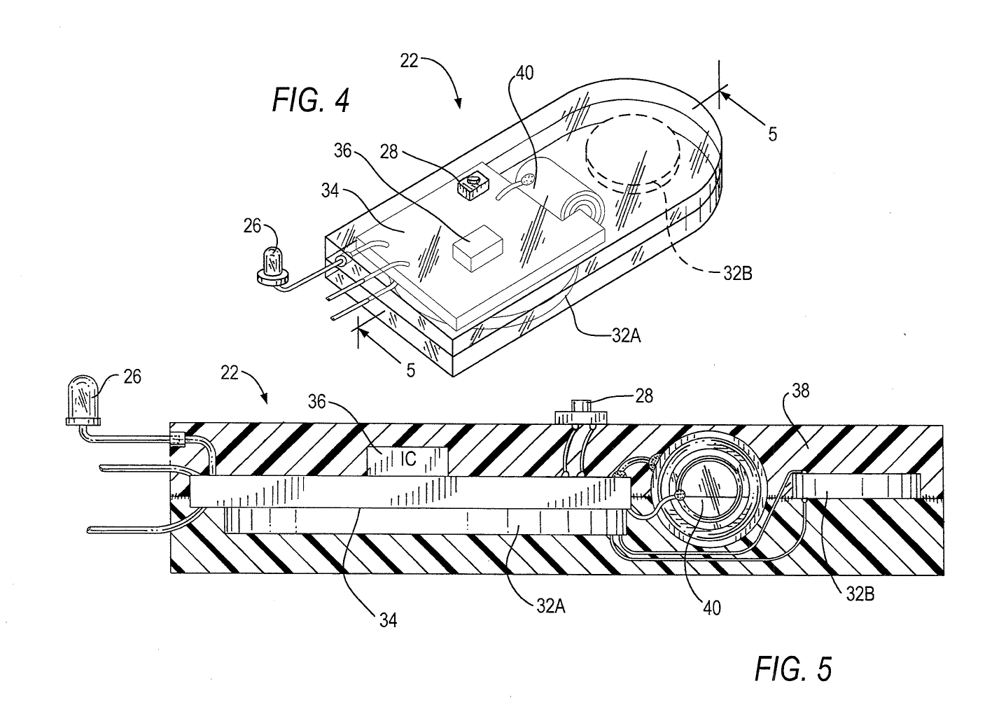

A lighting module 22, shown in isolation in FIG. 4, is mounted on the back or the front panel, e.g., in a pocket 24 in FIGS. 1 and 3, for supplying electrical power to energize the pluralities of LEDs to emit light. As shown in FIGS. 1, 3 and 5, an ambient light sensor 26 is connected to the module 22, for energizing the pluralities of LEDs upon detection of a predetermined ambient light level. Also, an on/off switch 28, as shown in FIGS. 4-5 is connected to the module 22, for energizing the pluralities of LEDs when the switch 28 is switched to an on state.

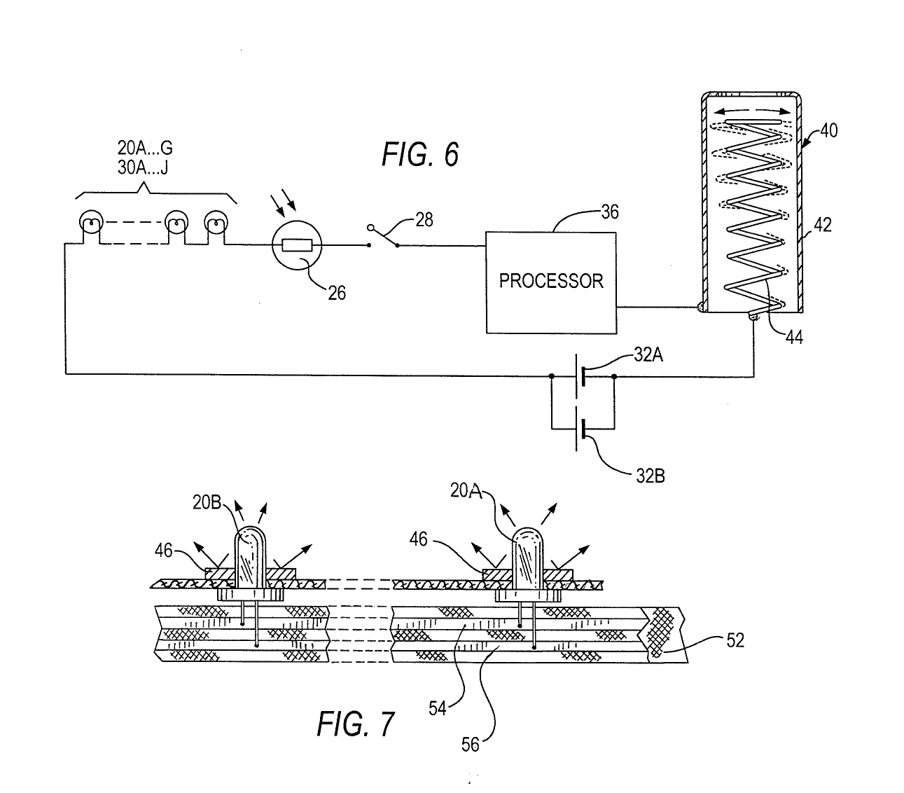

The lighting module 22 includes one or more batteries 32A, 32B, each typically being a flat circular disk battery commonly used in cameras, a planar support such as a printed circuit board 34, an integrated circuit processor 36 mounted on the board 34, and a motion-responsive switch 40 electrically connected to the processor 36, the batteries 32A, 32B, the ambient light sensor 26, the on/off switch 28, and the LEDs 20A . . . 20G, 30A . . . 30J in the manner illustrated in the circuit of FIG. 6.

The switch 40 includes an electrically conductive outer sleeve 42 in which an electrically conductive, cantilevered coil spring 44 is mounted for movement between an open position in which the spring 44 is located out of physical conductive contact with the sleeve 42, and a closed position in which the spring 44 contacts the sleeve 42. Motion of the spring 44 is caused by movement of the wearer and, to aid such spring motion, the free end of the cantilevered spring 44 can be weighted.

In the closed position of the switch 40, the processor 36 is energized by the batteries 32A, 32B and causes the LEDs to emit light, preferably flashes of light in a pattern determined by the processor 36. The pattern may be predetermined or random. The flashing can occur immediately when the closed position is reached, or after a time delay. The flashing is terminated after a predetermined time, or after a randomly chosen time interval. Continuous illumination is contemplated, but not preferred to minimize power consumption. The LEDs can emit light of the same or different colors. Such illumination is only permitted if the ambient light sensor 26 detects a predetermined ambient light level indicative of low visibility, e.g., during early morning or evening hours, and if the on/off switch 28 is actuated to the on or closed state.

As best seen in FIG. 5, the module 22 is encapsulated in a synthetic plastic material 38. The encapsulated module 22 has smooth, flattened major surfaces and rounded edges. All of the components inside the module 22 are potted inside the encapsulated plastic material 38, and there are no exposed rough edges. Water is prevented from entering and damaging the module 22 by the encapsulating plastic material 38.

In accordance with additional features of this invention, an eyelet 46, as best seen in FIGS. 3 and 7, surrounds and supports each LED on an exterior surface of the waist portion 18. Each eyelet 46 is constituted of a reflective material, e.g., a specular metal, which reflects the light emitted by the respective LED. Also, a pair of light-reflective bands 48, 50 extends along the waist portion 18 on the exterior surface thereof. The LEDs of the first row extend through the band 48, and the LEDs of the second row extend through the band 50. Both the eyelets 46 and the bands 48, 50 enhance the visibility of the garment 10. The bands 48, 50 may be constituted of a light-reflecting paint or color, and may be embossed with a pattern. Additional light-reflective bands may be provided vertically along the front panel portions 14A, 14B and vertically along the back panel 12.

In accordance with yet another feature of this invention, as shown in FIG. 7, a flexible, generally planar substrate 52 has a pair of generally planar conductive strips 54, 56 deposited thereon. The LEDs are connected to the module 22 by the conductive strips 54, 56. The flexible substrate 52 lies flat against an interior surface of the waist portion 18 and against the wearer's body. This feature enhances comfort, because the flexible substrate 52 conforms to the wearer's body and has no sharp or raised parts.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. For example, the switch 28 can be configured to have multiple switching states, in which one state enables the LEDS to be flashed according to one sequence, and another state enables the LEDS to be flashed according to a different sequence, and still another state enables the LEDS to be continuously illuminated.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, or contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. An illuminated protective garment, comprising:
a back panel overlying a back of a wearer's torso during use;
a front panel overlying a front of the wearer's torso during use;
a waist portion integral with the back and front panels and extending circumferentially around the wearer's waist during use;
a first plurality of light emitting diodes (LEDs) arranged in a first row along the waist portion in a spaced apart relationship, and extending through the back and front panels;
a second plurality of LEDs arranged in a second row along the waist portion in a spaced apart relationship, and extending through the back and front panels, the second row being generally parallel to the first row, and the LEDs of the first row being staggered in position relative to the LEDs of the second row; and
a module mounted on at least one of the back and front panels, for supplying electrical power to energize the pluralities of LEDs to emit light.

2. The garment of claim 1, wherein the module includes a motion-responsive switch for energizing the pluralities of LEDs in response to motion by the wearer.

3. The garment of claim 1, wherein the module includes a processor for energizing the pluralities of LEDs in a flashing pattern.

4. The garment of claim 1, and an ambient light sensor connected to the module, for energizing the pluralities of LEDs upon detection of a predetermined ambient light level.

5. The garment of claim 1, and a switch connected to the module, for energizing the pluralities of LEDs when the switch is switched to an on state.

6. The garment of claim 1, and an eyelet surrounding and supporting each LED on the waist portion, and wherein each eyelet is constituted of a reflective material that reflects the light emitted by the respective LED.

7. The garment of claim 1, and a pair of light-reflective bands extending along the waist portion, and wherein the LEDs of the first row extend through one of the bands, and wherein the LEDs of the second row extend through the other of the bands.

8. The garment of claim 1, wherein the module includes a battery pack and is water-resistant.

9. The garment of claim 1, and wherein the pluralities of LEDs are connected to the module by conductive strips deposited on a flexible substrate mounted on the waist portion.

10. An illuminated protective garment, comprising:
a back panel overlying a back of a wearer's torso during use;
a front panel overlying a front of the wearer's torso during use;
a waist portion integral with the back and front panels and extending circumferentially around the wearer's waist during use;
a first plurality of light emitting diodes (LEDs) extending through the back and front panels;
a second plurality of LEDs extending through the back and front panels;
a module mounted on at least one of the back and front panels, for supplying electrical power to energize the pluralities of LEDs to emit light; and
an ambient light sensor connected to the module, for energizing the pluralities of LEDs upon detection of a predetermined ambient light level.

11. The garment of claim 10, and an eyelet surrounding and supporting each LED on the waist portion, and wherein each eyelet is constituted of a reflective material that reflects the light emitted by the respective LED.

12. The garment of claim 10, and a pair of light-reflective bands extending along the waist portion, and wherein the LEDs extend through the bands.

13. The garment of claim 10, and wherein the pluralities of LEDs are connected to the module by conductive strips deposited on a flexible substrate mounted on the waist portion.

14. An illuminated protective garment, comprising:
a back panel overlying a back of a wearer's torso during use;
a front panel overlying a front of the wearer's torso during use;
a waist portion integral with the back and front panels and extending circumferentially around the wearer's waist during use;
a first plurality of light emitting diodes (LEDs) extending through the back and front panels;
a second plurality of LEDs extending through the back and front panels;
a module mounted on at least one of the back and front panels, for supplying electrical power to energize the pluralities of LEDs to emit light; and
a pair of light-reflective bands extending along the waist portion at an exterior surface thereof, the first plurality of LEDs extending through one of the bands, and the second plurality of LEDs extending through the other of the bands.

15. The garment of claim 14, and an eyelet surrounding and supporting each LED on the waist portion, and wherein each eyelet is constituted of a reflective material that reflects the light emitted by the respective LED.

16. The garment of claim 14, and wherein the pluralities of LEDs are connected to the module by conductive strips deposited on a flexible substrate mounted on the waist portion.
